(19) United States
(12) Patent Application Publication
(10) Pub. No.: US 2007/0108659 A1
(43) Pub. Date: May 17, 2007

(54) Aqueous release agent and its use in the production of polyurethane moldings

(75) Inventors: Ralf Althoff, Haltern (DE); Philippe Faure, Orsay (FR); Torsten Henning, Schwerin (DE)

Correspondence Address: Leopold Presser, Scully, Scott, Murphy & Presser, 400 Garden City Plaza, Garden City, NY, 11530, US

(73) Assignee: Goldschmidt GmbH, Essen (DE)

(21) Appl. No.: 11/589,417

(22) Filed: Oct. 30, 2006

(30) Foreign Application Priority Data
Nov. 12, 2005 (DE) 10 2005 054 036.8

(51) Int. Cl. C04B 35/66

(52) U.S. Cl. 264/300; 106/38.22

(57) ABSTRACT

The invention relates to aqueous dispersions containing agents having release activity, emulsifiers and customary auxiliaries and additives, wherein a combination of A) at least one agent having a release activity, selected from the group consisting of soaps, oils, waxes and silicones, and B) talc is used as agents having release activity.

### FIELD OF THE INVENTION

The present invention relates to aqueous release agents and their use in the production of polyurethane moldings.

### BACKGROUND OF THE INVENTION

It is known that the polyurethane systems used for the production of moldings show strong adhesion to the mold materials used, preferably thermally highly conductive materials, such as metals. In the demolding of the polyurethane moldings, release agents, which are applied to the mold walls coming into contact with polyurethanes and/or the polyurethane reaction mixture, are therefore required.

Such release agents consist of dispersions or emulsions of waxes, soaps, oils and/or silicones in solvents, such as hydrocarbons or water. After application of the release agent to the mold, the solvent evaporates and the non-volatile substances having release activity form a thin release film to allow the polyurethane molding to be easily removed from the mold after production.

In addition to the actually required release effect, the release agent also performs further functions; thus, it also greatly influences the surface of the polyurethane molding, which should be fine-pored or smooth and uniform, inter alia also for ensuring good coverability of the finished shaped articles with textiles or leather.

In order to reduce the environmental pollution with organic material, there is considerable interest in water-based release agents which are free of volatile organic material. However, compared with classical release agents containing organic solvents, the aqueous release agents on the market have the disadvantage that, after evaporation of a major part of the water, a thin water film remains in the mold. This water film does not volatilize at the usual mold temperatures of from 45° to 80° C., preferably from 50° to 75° C., and undergoes with the isocyanate compounds of the polyurethane system reactions that lead to very rigid polyurea compounds. The mold surfaces are adversely affected as a result, acquiring a so-called build-up and the mold surfaces have to be cleaned in a complicated manner.

Typical examples of aqueous release agents having a good demolding effect are described, for example, in DE-A-37 42 370 or DE-A-40 20 036, as these contain, as a substance having release activity, unsaturated oligomeric or polymeric hydrocarbons having molecular weights of at least 500 and iodine numbers of at least 60.

In addition to the above-described problem of polyurea build-up on the mold surfaces, however, these release agents also have the further disadvantage that the viscous oily release substance does not, in some cases, withstand the pressure of the injected and foaming polyurethane system and is displaced from the mold surface. This can result in the shaped article partly adhering to the mold and being damaged on the surface of the shaped article on removal from the mold.

U.S. Pat. No. 4,131,662 describes another type of release agent: a suspension of talc in an aqueous emulsion with low molecular weight organic material (molecular weight 200 or lower), preferably toluene, as an active substance having mold release activity, together with an organic solvent which is miscible with the low molecular weight organic material, preferably dichloromethane.

As described above, however, the environmental pollution with volatile organic material, as is present at molar masses of 200 or lower, is unacceptable.

In view of the above, there is an ongoing need for providing aqueous mold release agents that are free of organic solvents and volatile organic material with molar masses of 200 or lower, which have a good release effect, and which advantageously influence the surfaces of the polyurethane moldings; i.e., leave them fine-pored, uniform and smooth, leave behind no polyurea build-up on the mold surfaces and produce a release film which cannot be displaced by the pressure of the injected and foaming polyurethane system.

### SUMMARY OF THE INVENTION

Surprisingly, it has been found that an aqueous dispersion of classical substances having release activity, such as waxes, soaps, oils and/or silicones, in amounts of from 0.5 to 40% by weight, preferably from 3 to 20% by weight, in combination with talc in amounts of from 0.1 to 15% by weight, preferably from 0.5 to 10% by weight, based on the total aqueous formulation overcomes all of the drawbacks mentioned above relative to prior art release agents.

The present invention therefore relates to aqueous dispersions containing substantially water, agents having release activity and emulsifiers, wherein a combination of
A) at least one agent having a release activity, selected from the group consisting of soaps, oils, waxes and silicones, and
B) talc
   is used as agents having release activity.

The present invention furthermore relates to aqueous dispersions containing agents having release activity, emulsifiers and customary auxiliaries and additives, which consist of a combination of
A) from 0.5 to 40% by weight of at least one agent having release activity, selected from the group consisting of soaps, oils, waxes and silicones,
B) from 0.1 to 15% by weight of talc,
C) from 0.1 to 10% by weight of emulsifiers,
D) from 0.1 to 5% by weight of catalysts,
E) from 0.1 to 5% by weight of foam stabilizers,
F) from 0.1 to 2% by weight of viscosity modifiers,
G) from 0.1 to 2% by weight of customary preservatives, bactericides, fungicides and antioxidants, and
H) water to 100% by weight.

The invention also relates to the use of these release agents in the production of polyurethane moldings.

### DETAILED DESCRIPTION OF THE INVENTION

As stated above, the present invention provides an aqueous dispersion of classical substances having release activity, such as waxes, soaps, oils and/or silicones, in amounts of from 0.5 to 40% by weight, preferably from 3 to 20% by weight, in combination with talc in amounts of from 0.1 to 15% by weight, preferably from 0.5 to 10% by weight, based on the total aqueous formulation. The dispersion of the present invention can be used as release agents, particularly as release agents in the production of polyurethane moldings.

Talc is designated as an inorganic mineral from the family consisting of the layered silicates, including phyllosilicates, which mainly comprise magnesium silicate and contain various impurities, such as chlorite or other accompanying minerals. Mica, a layered silicates which contains large cations, such as K⁺, Na⁺ or Ca²⁺, is also suitable.

Talc having a composition of from 35 to 70% by weight of SiO₂, from 5 to 40% by weight of MgO, from 5 to 20% by weight of Al₂O₃ and from 1 to 5% by weight of Fe₂O₃ is preferably used. Lamellar talc having a composition of from 40 to 50% by weight of SiO₂, from 25 to 35% by weight of MgO, from 7 to 12% by weight of Al₂O₃, from 1.5 to 2.5% by weight of Fe₂O₃ and from 1 to 2% by weight of CaO is more preferably used.

Suitable talc products are sold, for example, under the trade names Luzenac®, Mistron®, French Velvet®, Ultrapure Talc®.

In accordance with the present invention, the presence of talc in the aqueous dispersion prevents the build-up of polyurea on the mold surfaces. Since, by strengthening the release film, talc promotes removal of the formed polyurea. The polyurea formed by the remaining unevaporated water is demolded with each demolding of a polyurethane molding, therefore no build-up forms on the mold surface when the inventive aqueous dispersion is employed.

Furthermore, talc stabilizes the substances frequently present as viscous oil and having release activity, so that the release film withstands the pressure of the injected and foaming polyurethane system and cannot be displaced from the mold surface.

Talc is generally gentle to the skin and is used, for example, in baby powder, so that no contact allergies are expected.

According to the present invention, for example, the following can be concomitantly used as classical substances having release activity and having average molar masses greater than 200, preferably 500
Waxes, i.e., liquid, solid, natural or synthetic waxes, also oxidized and/or partly hydrolyzed,
esters of carboxylic acids with alcohols or fatty alcohols,
metal salts, such as alkali metal or alkaline earth metal salts of fatty acids,
oils, such as hydrocarbons which are liquid or viscous at room temperature, optionally, but not preferably, with concomitant use of unsaturated oligomeric and/or polymeric hydrocarbons, and
silicones, such as polydimethylsiloxanes, optionally substituted by aliphatic or aromatic hydrocarbon radicals.

As customary auxiliaries and additives, one or more compounds may be selected from the group consisting of:

I) Emulsifiers:

anionic emulsifiers, such as alkyl ether carboxylates, alkyl sulfates, fatty alcohol ethoxylate ether sulfates, alpha-olefinsulfonates, alkyl phosphates, alkyl polyether phosphates, alkyl sulfosuccinates; nonionic emulsifiers, such as ethoxylated fatty alcohols, ethoxylated oxo alcohols and other alcohol ethers, fatty amines, such as dimethylalkylamines, fatty acid alkanolamides, fatty acid esters with alcohols, including glyceryl esters or polyglyceryl esters or sorbitol esters; cationic emulsifiers, such as alkyldimethylamines which have been rendered acidic, quaternary nitrogen compounds; finally zwitterionic surfactants, which are concomitantly used in amounts of from 0.1 to 10% by weight, preferably from 0.5 to 6% by weight;
   II) Catalysts:
those which are typically used for the polyurethane reaction, for example Lewis acids, such as tin compounds, or Lewis bases such as tertiary amines;
   III) Foam Stabilizers:
polysiloxane/polyether copolymers;
   IV) Viscosity Modifiers:
typical thickeners, such as polyacrylic acid derivatives designated as carbomers, or other polyelectrolyte thickeners, such as water-soluble cellulose derivatives or xanthan gum; and
   V) Customary Preservatives, Bactericides, Fungicides and Antioxidants.

The dispersions according to the invention can be prepared by processes known in the art. In a preferred procedure, the emulsifier is initially introduced with substances which have release activity and are in molten form (below the boiling point of water), a part of the water is then introduced under high shear force and thereafter the remaining water containing the further components is added with low shear force.

The present invention also relates to the use of the release agents described in the production of polyurethane moldings.

Typically, the mold is brought to the desired mold temperature of from 45° to 80° C., preferably from 50° to 75° C., and sprayed with a release agent, a certain time—from about 1 to 10 minutes depending on the amount of water—is allowed to pass until the major amount of water has evaporated and the reactive polyurethane system comprising polyols, polyisocyanates and optionally further additives, such as catalysts, foam stabilizers and blowing agents, is then pumped in. The mold is closed and, after the curing time, the mold is opened and the shaped article is removed.

The following examples serve for describing the invention in more detail without limiting it thereto.

List of substances used:
Luzenac® 2=lamellar talc comprising 46.0% by weight of SiO₂, 30.5% by weight of MgO, 9.8% by weight of Al₂O₃, 2.1% by weight of Fe₂O₃, 1.4% by weight of CaO, manufacturer: Luzenac,
DC® 190=polyether siloxane, manufacturer: Air Products,
Polyol® 130=polybutadiene having an average molar mass of about 3000 and iodine number of about 450 g of iodine/100 g, manufacturer: Degussa,
Unithox® 450=ethoxylated alcohol having an average molar mass of about 900, containing 50% by weight of ethylene oxide, corresponding to that used in example 1 from DE-A-40 20 036, manufacturer: Baker Petrolite,
Fatty amine=R—NH₂, where R═C₁₂₋₂₂, optionally branched, alkyl radicals,
Microwax=commercially available waxes having a solidification temperature of from 50° to 90° C.,
Polyethylene wax=commercially available waxes having a solidification temperature of from 50° to 90° C.,
Desmophen® PU 21IK01=polyetherpolyol, manufacturer: Bayer,
Tegoamin® TA 33, manufacturer: Degussa,
Tegoamin® AS-1, manufacturer: Degussa,
Tegostab® EP-K-38=organomodified siloxane, manufacturer: Degussa,
Suprasec® 2412=diphenylmethane 4,4′-diisocyanate, manufacturer: Huntsman.

### EXAMPLE 1

Release Agent 1:

1% by weight of polyethylene wax (solidification point 60° C.), 5% by weight of microwax (solidification point 70° C.), 1% by weight of fatty amine, 0.02% by weight of acetic acid (60% in water), 1% by weight of Luzenac® 2, 1% by weight of DC® 190, 90.98% by weight of water.

### EXAMPLE 2

Release Agent 2:

1% by weight of polyethylene wax (solidification point 60° C.), 5% by weight of microwax (solidification point 70° C.), 1% by weight of fatty amine, 0.02% by weight of acetic acid (60% in water), 5% by weight of Luzenac® 2, 1% by weight of DC® 190, 86.98% by weight of water.

### EXAMPLE 3

Release Agent 3:

1% by weight of polyethylene wax (solidification point 60° C.), 5% by weight of microwax (solidification point 70° C.), 1% by weight of fatty amine, 0.02% by weight of acetic acid (60% in water), 10% by weight of Luzenac® 2, 1% by weight of DC® 190, 0.25% of Xanthan gum, 81.73% by weight of water.

### Comparative Example A

(Based on Example 7 from U.S. Pat. No. 4,131,662, which received the best rating in this document, but without organic solvents, such as toluene and dichloromethane, which should no longer be used):
10% by weight of Luzenac® 2, 1% by weight of sodium oleate, 89% by weight of water.

### Comparative Example B

(based on Example no. 1 from DE-A-40 20 036):
16% by weight of Polyol® 130, 4% by weight of Unithox® 450, 1% by weight of DC® 190, 79% by weight of water.

Release Agent Experiments:

The release agents were sprayed onto test metal plates by means of a 0.5 mm nozzle in amounts of 20 g/m² similar to those used in practice, and a foamable polyurethane system consisting of 100 parts of Desmophen® PU 21IK01, 3.5 parts of water, 0.4 part of Tegoamin® TA 33, 0.25 part of Tegoamin® AS-1, 0.7 part of diethanolamine, 0.5 part of Tegostab® EP-K-38, 0.2 part of acetic acid (60% in water) and 63.5 parts of Suprasec® 2412 was foamed on these sheets in a box mold at 55° C.

After curing (10 minutes), the metal sheets were peeled off from the foam using a spring force meter, in order to measure the extent of the release effect.

Evaluation of the Release Experiments:

| | Force for peeling off the metal | Assessment of the foam |
|---|---|---|
| Release agent | sheet from the foam [kg] | surface |
| 1 | 1.8 | slightly closed, dry |
| 2 | 1.3 | open, dry |
| 3 | 1.3 | Fine-pored, open, dry |
| A | 1.3 | Fine-pored, open, dry |
| B | 2.0 | slightly closed, greasy |

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. Aqueous dispersion comprising substantially water, agents having release activity and emulsifiers, wherein said agents include at least a combination of
A) at least one agent having a release activity, selected from the group consisting of soaps, oils, waxes and silicones, and
B) talc.

2. The aqueous dispersion as claimed in claim 1, comprising
A) from 0.5 to 40% by weight of said at least one agent having release activity, selected from the group consisting of soaps, oils, waxes and silicones, and
B) from 0.1 to 15% by weight of talc.

3. The aqueous dispersion as claimed in claim 2, further comprising
C) from 0.1 to 10% by weight of emulsifiers,
D) from 0.1 to 5% by weight of catalysts,
E) from 0.1 to 5% by weight of foam stabilizers,
F) from 0.1 to 2% by weight of viscosity modifiers,
G) from 0.1 to 2% by weight of customary preservatives, bactericides, fingicides and antioxidants, and
H) water to 100% by weight.

4. The aqueous dispersion as claimed in claim 1, wherein the agents A) having a release activity have an average molar mass of greater than 200.

5. The aqueous dispersion as claimed in claim 1, wherein at least one compound selected from the group consisting of the liquid, solid, natural or synthetic waxes, oils, esters of carboxylic acids with alcohols or fatty alcohols, metal soaps and silicones is concomitantly used as agents A) having a release activity.

6. The aqueous dispersion as claimed in claim 1, wherein said talc B) is an inorganic mineral from the family consisting of the sheet silicates.

7. The aqueous dispersion as claimed in claim 1, wherein said talc B) is a talc having a composition of from 35 to 70% by weight of SiO₂, from 5 to 40% by weight of MgO, from 5 to 20% by weight of Al₂O₃ and from 1 to 5% by weight of Fe₂O₃.

8. The aqueous dispersion as claimed in claim 1, wherein said emulsfiers comprise at least one compound selected from the group consisting of the anionic, cationic, zwitterionic and nonionic surfactants.

9. A method for producing a polyurethane molding comprising adding at least an aqueous dispersion of claim 1 to surfaces of a mold prior to adding a reactive polyurethane system to said mold.

10. The method as claimed in claim 9, wherein said mold is heated prior to adding the aqueous dispersion to said mold.

11. The method as claimed in claim 10, wherein said mold is heated to a temperature from 45° to 80° C.

12. The method as claimed in claim 9, comprising
A) from 0.5 to 40% by weight of said at least one agent having release activity, selected from the group consisting of soaps, oils, waxes and silicones, and
B) from 0.1 to 15% by weight of talc.

13. The method as claimed in claim 12, further comprising
C) from 0.1 to 10% by weight of emulsifiers,
D) from 0.1 to 5% by weight of catalysts,
E) from 0.1 to 5% by weight of foam stabilizers,
F) from 0.1 to 2% by weight of viscosity modifiers,
G) from 0.1 to 2% by weight of customary preservatives, bactericides, fingicides and antioxidants, and
H) water to 100% by weight.

14. The method as claimed in claim 9, wherein the agents A) having a release activity have an average molar mass of greater than 200.

15. The method as claimed in claim 9, wherein at least one compound selected from the group consisting of the liquid, solid, natural or synthetic waxes, oils, esters of carboxylic acids with alcohols or fatty alcohols, metal soaps and silicones is concomitantly used as agents A) having a release activity.

16. The method as claimed in claim 9, wherein said talc B) is an inorganic mineral from the family consisting of the sheet silicates.

17. The method as claimed in claim 9, wherein said talc B) is a talc having a composition of from 35 to 70% by weight of SiO₂, from 5 to 40% by weight of MgO, from 5 to 20% by weight of Al₂O₃ and from 1 to 5% by weight of Fe₂O₃.

18. The method as claimed in claim 9, wherein said emulsfiers comprise at least one compound selected from the group consisting of the anionic, cationic, zwitterionic and nonionic surfactants.
